(19) United States
(12) Patent Application Publication
(10) Pub. No.: US 2026/0072368 A1
(43) Pub. Date: Mar. 12, 2026

(54) POSITIVELY CHARGEABLE TONER AND TWO-COMPONENT DEVELOPER INCLUDING POSITIVELY CHARGEABLE TONER

(71) Applicant: KYOCERA Document Solutions Inc., Osaka (JP)

(72) Inventor: Masanori SUGAHARA, Osaka (JP)

(73) Assignee: KYOCERA Document Solutions Inc., Osaka (JP)

(21) Appl. No.: 19/317,889

(22) Filed: Sep. 3, 2025

(30) Foreign Application Priority Data
Sep. 9, 2024 (JP) 2024-155122

(51) Int. Cl. G03G 9/093; G03G 9/087; G03G 9/113

(52) U.S. Cl. CPC G03G 9/09321; G03G 9/08755; G03G 9/09342; G03G 9/1131; G03G 9/1135

(57) ABSTRACT

A positively chargeable toner includes toner particles each including a toner base particle and an external additive. The toner base particle contains, at least, a binder resin, a colorant, and a release agent. The external additive includes an inorganic particle and a resin particle. The resin particle contains a cationic surfactant, has a volume average particle size of 40 nm or more but 110 nm or less, and has a hardness of 1 μN or higher when measured with a probe displacement of 40 nm. Where ΔSP1 is a difference between an SP value of the release agent and an SP value of the resin particle, and ΔSP2 is a difference between an SP value of the binder resin and the SP value of the resin particle, 0.8≤ΔSP1≤1.1 (cal/cm³)^{1/2} and 1.3≤ΔSP2≤1.6 (cal/cm³)^{1/2} are satisfied.

### INCORPORATION BY REFERENCE

This application is based on and claims the benefit of priority from Japanese Patent Application No. 2024-155122 filed on Sep. 9, 2024, the contents of which are hereby incorporated by reference.

### BACKGROUND

The present disclosure relates to a positively chargeable toner for electrostatic latent image development and a two-component developer including the positively chargeable toner.

In general, in electrophotographic methods, a surface of an electrostatic latent image carrier is electrostatically charged by corona discharge or the like, and is then exposed to laser light or the like to form an electrostatic latent image. The resulting electrostatic latent image is developed with toner to form a toner image. Further, the resulting toner image is transferred onto a recording medium to obtain a high-quality image. Typically used as toner for use in electrophotographic methods are toner particles (toner base particles) produced by mixing a binder resin such as a thermoplastic resin with a colorant, a charge control agent, a release agent, and the like and then subjecting the mixture to kneading, pulverizing, and classifying.

The recent trend of toners with lower melting points has led to an issue where, upon heating in a fixing portion, components of the binder resin and the release agent (wax) undergo thermal decomposition, becoming volatilized and ultimately serving as a source of ultrafine particles (UFPs).

### SUMMARY

According to one aspect of the present disclosure, a positively chargeable toner includes toner particles each including a toner base particle and an external additive. The toner base particle contains, at least, a binder resin, a colorant, and a release agent. The external additive attaches to the surface of the toner base particle. The external additive includes an inorganic particle and a resin particle. The resin particle contains a cationic surfactant, has a volume average particle size of 40 nm or more but 110 nm or less, and has a hardness of 1 μN or higher when measured with a probe displacement of 40 nm. Expressions (1) and (2) below are satisfied, where ΔSP1 is a difference between an SP value of the release agent and an SP value of the resin particle, and ΔSP2 is a difference between an SP value of the binder resin and the SP value of the resin particle:

$$0.8 ≦ Δ SP 1 ≦ 1.1 {( cal / {cm}^{3} )}^{1 / 2} ; \qquad ( 1 )$$

$$1.3 ≦ Δ SP 2 ≦ 1.6 {( cal / {cm}^{3} )}^{1 / 2} . \qquad ( 2 )$$

### BRIEF DESCRIPTION OF THE DRAWING

FIG. 1 is a diagram showing one example of the sectional structure of a toner according to the present disclosure for use in a two-component developer.

### DETAILED DESCRIPTION

An embodiment of the present disclosure will be described in detail below. Unless otherwise defined, a result of evaluation (i.e., a value related to a shape, property, or the like) with respect to a powdery substance (specifically, toner core particle, toner base particle, external additive, toner, and the like) is given as a number average of values obtained respectively for an appropriate number of average particles selected from the powdery substance. Unless otherwise defined, a number average particle size of a powdery substance is a number average value of the circle-equivalent diameter (the diameter of a circle with the same area as the projection area of a particle) of primary particles measured under a microscope. Unless otherwise defined, a measured value of the volume median diameter (D50) of a powdery substance is a value measured using a laser diffraction/scattering particle size distribution analyzer (LA-750, manufactured by Horiba Ltd.). Unless otherwise defined, a measured value of an acid number or a hydroxy group number is a value measured in conformity with JIS (Japanese Industrial Standards) K0070-1992. Unless otherwise defined, a measured value of a number average molecular weight (Mn) or a mass average molecular weight (Mw) is a value measured by gel permeation chromatography.

Unless otherwise defined, a softening point (Tm) is a value measured using a Koka-type flow tester (CFT-500D, manufactured by Shimadzu Corporation). On an S-curve (horizontal axis: temperature, vertical axis: stroke) plotted using the Koka-type flow tester, the temperature corresponding to a stroke value of “(baseline stroke value+maximum stroke value)/2” corresponds to the softening point (Tm). Unless otherwise defined, a measured value of a melting point (Mp) is a temperature at a maximum endothermic peak on an endothermic curve (vertical axis: heat flow (DSC signal), horizontal axis: temperature) as plotted using a differential scanning calorimeter (DSC-6220, manufactured by Seiko Instruments Inc.). The endothermic peak appears due to melting of a crystalline region. Unless otherwise defined, a glass transition point (Tg) is a value measured using a differential scanning calorimeter (DSC-6220, manufactured by Seiko Instruments Inc.), in conformity with JIS (Japanese Industrial Standards) K7121-2012. A temperature corresponding to an inflection point (specifically, temperature at an intersection point of an extrapolated baseline and an extrapolated falling line) caused by glass transition on an endothermic curve (vertical axis: heat flow (DSC signal), horizontal axis: temperature) as plotted using the differential scanning calorimeter corresponds to Tg (glass transition point).

Unless otherwise defined, the SP value (solubility parameter), a parameter defined by the expression “SP value=(E/V)^{1/2}” (E: cohesive energy (cal/mol), V: molar volume (cm³/mol])), is a value (unit: (cal/cm³)^{1/2}, temperature: 25° C.) calculated according to Fedors' calculation method. For details of Fedors' calculation method, see R. F. Fedors, “Polymer Engineering and Science”, Vol. 14, No. 2 (issued in 1974), pp. 147-154.

In the following description, “-based” is occasionally appended to the name of a compound to collectively refer to that substance and their derivatives. Wherever the name of a compound has “-based” appended to it in the name of a polymer, the recurring unit in the polymer is derived from any of that compound and their derivatives. The term “(meth)acrylic” is occasionally used to refer to “acrylic” and “methacrylic” collectively. The term “(meth)acryloyl” is occasionally used to refer to “acryloyl” (CH₂═CH—CO—) and “methacryloyl” (CH₂═C(CH₃)—CO—) collectively.

Toner according to the present embodiment can be used as positively chargeable toner suitably for development of electrostatic latent images. The toner according to the present embodiment is a powdery substance containing a plurality of toner particles (each having a configuration described later). The toner can be used as one-component developer. Further, the toner can be mixed with carrier using a mixing apparatus (e.g., a ball mill) to prepare two-component developer. To form high-quality images, it is preferable to use ferrite carrier as the carrier.

Further, to form high-quality images over a long period, it is preferable to use magnetic carrier particles that have a carrier core and a resin layer coating the carrier core. To produce magnetic carrier particles, the carrier core may be formed with a magnetic material (e.g., ferrite) or the carrier core may be formed with resin having magnetic particles dispersed in it. Or, magnetic particles can be dispersed in the resin layer coating the carrier core. To form high-quality images, the amount of toner in two-component developer is preferably 5 mass parts or more but 15 mass parts or less relative to 100 mass parts of carrier. Positively chargeable toner is charged positive by friction with carrier.

The toner particles contained in the toner according to the present embodiment have a toner base particle and an external additive attached to the surface of the toner base particle. That is, a toner particle before an external additive is attached to it is referred to as a toner base particle. Further, in a case where the toner base particle has a shell layer, a toner particle before a shell layer is formed on it is referred to as a toner core particle. In a case where the toner base particle does not have a shell layer, the toner base particle may also be referred to as a toner core particle.

The toner according to the present embodiment can be used, for example, to form images in an electrophotographic apparatus (image forming apparatus). One example of an image formation method on an electrophotographic apparatus will be described below.

First, based on image data, an electrostatic latent image is formed on a photosensitive member (e.g., in a superficial part of a photosensitive drum). Next, the resulting electrostatic latent image is developed using developer that contains toner. In the development process, toner (e.g., toner electrostatically charged by friction with carrier or a blade) on a development sleeve (e.g., a superficial part of a development roller in a developing device) disposed near the photosensitive member is attached to the electrostatic latent image to form a toner image on the photosensitive member. In the subsequent transfer process, the toner image on the photosensitive member is transferred directly onto a recording medium (e.g., a sheet of paper). Or, it is first primarily transferred to an intermediate transfer member (e.g., a transfer belt) and then the toner image on the intermediate transfer member is secondarily transferred to a recording medium. After that, the toner is heated, so that the toner is fixed to the recording medium. As a result, an image is formed on the recording medium. By superposing on each other toner images of four colors, for example, black, yellow, magenta, and cyan, it is possible to form a full-color image.

### [1. Basic Configuration of Toner]

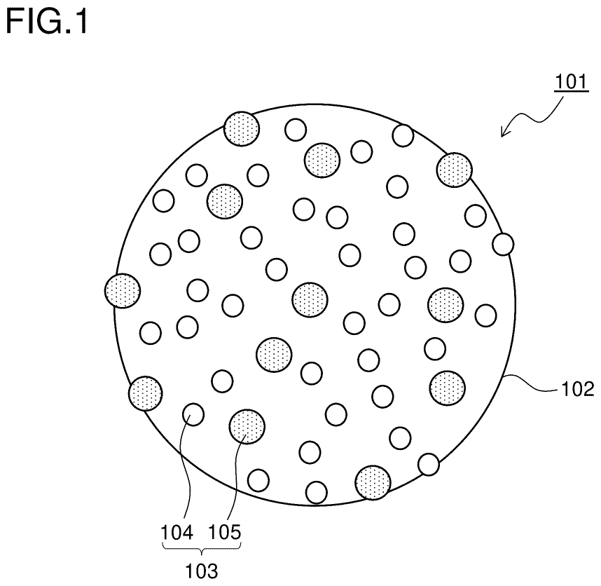

FIG. 1 is a diagram showing one example of the sectional structure of a positively chargeable toner 101 according to the present disclosure. As shown in FIG. 1, the positively chargeable toner (hereinafter, also referred to simply as the toner) 101 of the present disclosure has a toner base particle 102 and an external additive 103 attached to the surface of the toner base particle 102. The toner base particle 102 at least contains a binder resin, a colorant, and a release agent. The external additive 103 includes an inorganic particle 104 and a resin particle 105.

The resin particle 105 is used as a spacer particle. The volume average particle size of the resin particle 105 is 40 nm or more but 140 nm or less. If the volume average particle size of the resin particle 105 is less than 40 nm, the fixation of the resin particle 105 with respect to the surface of the toner base particle 102 is facilitated, but the resin particle 105 cannot provide a satisfactory effect as a spacer, exerting a weaker effect on suppressing the sinking of the resin particle 105. If the volume average particle size of the resin particle 105 exceeds 140 nm, the fixation of the resin particle 105 with respect to the surface of the toner base particle 102 is hindered, and thus the resin particle 105 may be released, causing contamination of a carrier or a component inside the image forming apparatus.

In the toner 101 of the present disclosure, for the purpose of suppressing the thermal decomposition of the release agent contained in the toner base particle 102, Expression (1) below is satisfied, where ΔSP1 is a difference between an SP value of the release agent exposed on the surface of the toner base particle 102 and an SP value of the resin particle 105.

$$0.8 ≦ Δ SP 1 ≦ 1.1 {( cal / {cm}^{3} )}^{1 / 2} \qquad ( 1 )$$

With ΔSP1 satisfying Expression (1), shear mixing energy during the external addition treatment facilitates the fixation of the resin particle 105 with respect to the release agent exposed on the surface of the toner base particle 102. As a result, when the toner 101 reaches the fixing portion inside the image forming apparatus to be exposed to heat energy and pressure, it is possible to suppress thermal decomposition of the release agent unnecessary for releasing and thus to reduce the amount of UFPs generated.

If ΔSP1 is less than 0.8, the resin particle 105 becomes more likely to sink into the release agent exposed on the surface of the toner base particle 102, becoming less effective as a spacer, which result in degraded durability against mechanical stress. On the other hand, if ΔSP1 exceeds 1.1, the shear mixing energy during the external addition treatment hinders the fixation of the resin particle 105 with respect to the release agent exposed on the surface of the toner base particle 102, increasing the tendency of the resin particle 105 to come off. As a result, the thermal decomposition of the release agent proceeds when the toner 101 reaches the fixing portion inside the image forming apparatus, leading to an increase in the amount of UFPs generated.

Further, Expression (2) is satisfied, where ΔSP2 is a difference between an SP value of the binder resin contained in the toner base particle 102 and the SP value of the resin particle 105.

$$1.3 ≦ Δ SP 2 ≦ 1.6 {( cal / {cm}^{3} )}^{1 / 2} \qquad ( 2 )$$

With ΔSP2 satisfying Expression (2), the fixation of the resin particle 105 with respect to the binder resin exposed on the surface of the toner base particle 102 is facilitated, improving the durability of the spacer effect against mechanical stress and environmental changes. Further, the amount of the resin particle 105 released to exist on the edge portion of a cleaning blade in contact with the surface of a photosensitive drum is reduced, and thus passing-through of the external additive 103 is suppressed, contributing to improvement of drum-cleaning properties.

If ΔSP2 is less than 1.3, the fixation of the resin particle 105 with respect to the binder resin is facilitated, but the sinking of the resin particle 105 becomes more likely to progress, degrading toner charge stability and toner flowability. On the other hand, if ΔSP2 exceeds 1.6, the fixation of the resin particle 105 with respect to the binder resin is hindered, and thus a sufficient spacer effect cannot be obtained. Further, during the development of the toner on the surface of the photosensitive drum, the resin particle 105 may be released to move to the photosensitive drum together with toner, and may remain on the surface of the photosensitive drum after the transfer. Then, the resin particle 105 having passed through the cleaning blade without being removed from the surface of the photosensitive drum contaminates a charging roller, increasing the likelihood of variations in the surface potential of the photosensitive drum.

Further, the hardness of the resin particle 105 is set to be 1 μN or higher (with a probe displacement amount of 40 nm). With this setting, filming of the resin particle 105 on the surface of the photosensitive drum is suppressed, helping to minimize poor drum cleaning. If the hardness of the resin particle 105 is lower than 1 μN, filming of the resin particle 105 occurs on the surface of the photosensitive drum to destabilize the stick-slip motion of the cleaning blade, increasing the likelihood of insufficient drum cleaning.

### [2. Materials of Toner]

Next, a description will be given of the essential or optional components of the toner according to the present disclosure. The toner core particle contains, in the binder resin, at least a release agent and a colorant. The toner core particle may further contain, as necessary, a charge control agent, a magnetic powder, and the like, or may have a shell layer formed on its surface. In the toner according to the present disclosure, the toner core particle (the toner base particle) has its surface treated with an external additive.

Now, a description will be given one by one of the binder resin, the release agent, the colorant, the charge control agent, and the magnetic powder that form the toner core particle, a shell material used in a case where a shell layer is formed on the toner core particle, and the external additive externally added to the toner core particle (the toner base particle), as well as the method of producing the toner according to the present disclosure.

### (Binder Resin)

The toner core particle of the toner according to the present disclosure contains a binder resin. The binder resin that can be contained in the toner core particle is not particularly limited so long as it is a resin known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, polyester resins are preferable from the viewpoints of the dispersion properties of the colorant in the binder resin, the chargeability of the toner, and the fixability of the toner to sheets. Hereinafter, a description will be given of the polyester resin.

Usable polyester resins here are those obtained by condensation polymerization or condensation copolymerization of a dihydric or a trihydric or higher alcohol component and a divalent or a trivalent or higher carboxylic acid component. Examples of components used to synthesize a polyester resin include alcohol components and carboxylic acid components as mentioned below.

Specific examples of dihydric or trihydric or higher alcohol components include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentacrythritol, 1,2,4-butantriol, 1,2,5-pentantriol, glycerol, diglycerol, 2-methylpropan triol, 2-methyl-1,2,4-butantriol, trimethylolethane, trimethylolpropane, and 1,3,5-trihydroxymethylbenzene.

Specific examples of divalent or trivalent or higher carboxylic acid components include: divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azclaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and empole trimer acid. These divalent or trivalent or higher carboxylic acid components can be used as ester-forming derivatives such as acid halides, acid anhydrides, and lower alkyl esters. Here, the term “lower alkyl” denotes an alkyl group with one to six carbon atoms.

When the binder resin is a polyester-based resin, the softening point of the polyester-based resin is preferably 70° C. or higher but 130° C. or lower, and more preferably 80° C. or higher but 120° C. or lower. For improved toner-core mechanical strength and improved toner fixability, the number average molecular weight (Mn) of the polyester resin is preferably 1000 or more but 2000 or less. The molecular weight distribution of the polyester resin (the ratio Mw/Mn of the mass average molecular weight (Mw) of the polyester resin to its number average molecular weight (Mn)) is preferably 9 or more but 21 or less.

As the binder resin, it is preferable to use a thermoplastic resin for its satisfactory fixability to sheets. Here, a thermoplastic resin can be used not only singly but also with a cross-linking agent or a thermosetting resin added to it. Adding a cross-linking agent or a thermosetting resin so that the binder resin partly have a cross-linked structure helps improve toner heat-resistant preservability, durability, and the like without degrading the toner fixability. When a thermosetting resin is used, the cross-linked fraction (gel fraction) of the binder resin extracted using a Soxhlet extractor is, preferably, relative to the mass of the binder resin, 10 mass % or less, and more preferably 0.1 mass % or more but 10 mass % or less.

As a thermosetting resin useable with a thermoplastic resin, an epoxy resin or a cyanate-based resin is preferable. Specific examples of suitable thermosetting resins include bisphenol A-type epoxy resins, hydrogenated bisphenol A-type epoxy resins, novolac-type epoxy resins, polyalkylene ether-type epoxy resins, cyclic aliphatic compound-type epoxy resins, and cyanate resins. Two or more of these thermosetting resins can be used in combination.

The glass transition point (Tg) of the binder resin is preferably 40° C. or higher but 70° C. or lower. Too high a glass transition point tends to lead to poor low-temperature fixability of the toner. Too low a glass transition point tends to lead to poor heat-resistant preservability.

The glass transition point of the binder resin can be determined from the changing point of the specific heat of the binder resin using a differential scanning calorimeter (DSC). More specifically, the glass transition point of the binder resin can be determined by drawing the endothermic curve of the binder resin using as a measuring instrument a differential scanning calorimeter (DSC-6200, manufactured by Seiko Instruments Inc.). 10 mg of a measurement sample is put in an aluminum pan, while a vacant aluminum pan is used as a reference. From the endothermic curve of the binder resin drawn through measurement in a normal-temperature normal-humidity environment in the range of measurement temperature from 25° C. to 200° C. at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polyethylene resin.

### (Release Agent)

For the purpose of improving its fixability and offset resistance, the toner core particle contains a release agent. The type of release agent that can be contained in the toner core particle is not limited within the scope consistent with the object of the present disclosure. As the release agent, wax is preferable, of which examples include carnauba wax, synthetic ester wax, polyethylene wax, polypropylene wax, fluororesin-based wax, Fischer-Tropsch wax, paraffin wax, montan wax, and rice wax. Two or more of these release agents can be used in combination. Adding these release agents to the toner core particle helps more effectively suppress offsetting and image smearing (stain around an image caused by its being rubbed).

When polyester resin is used as the binder resin, from the viewpoint of compatibility, one or more selected from the group consisting of carnauba wax, synthetic ester wax, and polyethylene wax are suitably used. When polystyrene resin is used as the binder resin, likewise from the viewpoint of compatibility, Fischer-Tropsch wax and/or paraffin wax are/is suitably used.

Note that Fischer-Tropsch wax is a straight-chain hydrocarbon compound with few iso-structure molecules or side chains that is produced by exploiting the Fischer-Tropsch reaction, which is a catalytic hydrogenation reaction of carbon monoxide.

More preferable among different types of Fischer-Tropsch wax are those that have a mass average molecular weight of 1,000 or more and of which the bottom temperature of the exothermal peak observed by DSC measurement falls within the range of 100° C. or higher but 120° C. or lower. Examples of such types of Fischer-Tropsch wax include the following products available from Sasol Ltd.: Sasol Wax Cl (exothermic peak bottom temperature: 106.5° C.), Sasol Wax C105 (exothermic peak bottom temperature: 102.1° C.), and Sasol Wax SPRAY (exothermic peak bottom temperature: 102.1° C.).

The amount of release agent used is not particularly limited within the scope consistent with the object of the present disclosure. Specifically, the amount of release agent used is preferably 1 mass % or more but 10 mass % or less relative to the total mass of the toner core particle. Too small an amount of release agent used may result in insufficient suppression of offsetting and image smearing in image formation; too large an amount of release agent used may result in fusing-together of toner particles and hence poor heat-resistant preservability.

### (Colorant)

The toner core particle contains a colorant. As the colorant that can be contained in the toner core particle, any known pigment or dye that suits the color of the toner can be used. Specific examples of suitable colorants that can be added to the toner include: black pigments such as carbon black, acetylene black, lamp black, and aniline black; yellow pigments such as chrome yellow, zinc yellow, cadmium yellow, yellow iron oxide, mineral fast yellow, nickel titanium yellow, Naples yellow, naphthol yellow S, Hansa yellow G, Hansa yellow 10G, benzidine yellow G, benzidine yellow GR, quinoline yellow lake, permanent yellow NCG, tartrazine lake, monoazo yellow, and diazo yellow; orange pigments such as reddish chrome yellow, molybdenum orange, permanent orange GTR, pyrazolone orange, Vulcan Orange, and indanthrene brilliant orange GK; red pigments such as red iron oxide, cadmium red, red lead, mercury cadmium sulfide, Permanent Red 4R, lithol red, pyrazolone red, Watchung red calcium salt, lake red D, brilliant carmine 6B, cosine lake, rhodamine lake B, alizarin lake, brilliant carmine 3B, and monoazo red; violet pigments such as manganese violet, fast violet B, and methyl violet lake; blue pigments such as Prussian blue, cobalt blue, alkali blue lake, partially chlorinated Victoria blue, fast sky blue, indanthrene blue BC, and phthalocyanine blue; green pigments such as chrome green, chromium oxide, pigment green B, malachite green lake, and final yellow green G; White pigments such as zinc white, titanium oxide, antimony white, and zinc sulfide; and extender pigments such as barite powder, barium carbonate, clay, silica, white carbon, talc, and alumina white. Two or more of these pigments can be used in combination for the purpose, among others, of adjusting the toner to the desired hue.

The amount of colorant used is not particularly limited within the scope consistent with the object of the present disclosure. Specifically, the amount of colorant used is, relative to the total mass of the toner core particle, preferably 1 mass % or more but 10 mass % or less, and more preferably 2 mass % or more but 7 mass % or less.

A colorant can be used as a masterbatch having a colorant previously dispersed in a resin material such as a thermoplastic resin. When a colorant is used as a masterbatch, the resin contained in the master batch is preferably a resin of the same type as the binder resin.

### (Charge Control Agent)

It is preferable that the toner core particle contain a charge control agent for the purpose of improving the charge level of the toner and its charge rising properties as an index of whether it can be charged to a predetermined charge level in a short time and thereby obtaining toner with excellent durability and stability. Since the toner 101 according to the present disclosure is a positively chargeable toner, a positively chargeable charge control agent is used.

The type of charge control agent to be contained in the toner core particle is not particularly limited within the scope consistent with the object of the present disclosure. Any of charge control agents conventionally known to be used in toner can be appropriately selected and used. Specific examples of positively chargeable charge control agents include: azine compounds such as pyridazine, pyrimidine, pyrazine, orthoxazine, metaoxazine, paraoxiazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tctrazine, 1,2,4,6-oxatriazine, 1,3,4,5-oxatriazine, phthalazine, quinazoline, and quinoxaline; direct dyes composed of azine compounds, such as azine fast red FC, azine fast red 12BK, azine violet BO, azine brown 3G, azine light brown GR, azine dark green BH/C, azine deep black EW, and azine deep black 3RL; nigrosine compounds such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; alkoxylated amines; alkylamides; and quaternary ammonium salts such as benzylmethylhexyldecylammonium and decyltrimethylammonium chloride. Among these positively chargeable charge control agents, nigrosine compounds are particularly preferable for their faster charge rising. Two or more of these positively chargeable charge control agents can be used in combination.

Also usable as a positively chargeable charge control agent are resins that have as a functional group a quaternary ammonium salt, a carboxylic acid salt, or a carboxyl group. Specific examples include styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weights of these resins are not particularly limited within the scope consistent with the object of the present disclosure, and they can be in the form of an oligomer or a polymer.

Among resins usable as a positively chargeable charge control agent, from the viewpoint of easy adjustment of the amount of charge within a desired range, styrene-acrylic-based resin having as a functional group a quaternary ammonium salt is more preferable. In styrene-acrylic-based resins having as a functional group a quaternary ammonium salt, specific examples of preferable acrylic-based comonomers for copolymerization with the styrene unit include esters of alkyl (meth)acrylates such as methyl acrylate, ethyl acrylate, n-propyl acrylate, isopropyl acrylate, n-butyl acrylate, isobutyl acrylate, 2-ethylhexyl acrylate, methyl methacrylate, ethyl methacrylate, n-butyl methacrylate, and isobutyl methacrylate.

Used as a quaternary ammonium salt is a unit derived by a quarternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acryl amide include dimethyl methacryl amide. Specific examples of dialkyl aminoalkyl (meth)acryl amide include dimethyl aminopropyl methacryl amide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The amount of charge control agent used is not particularly limited within the scope consistent with the object of the present disclosure. Typically, the amount of charge control agent used is preferably 0.1 mass % or more but 10 mass % or less of the total mass of the toner core particle. Too small an amount of charge control agent used makes it difficult to stably charge the toner with a predetermined polarity. This can lead to a lower-than-expected image density in the formed image and make it difficult to maintain satisfactory image density for a long period. Also the charge control agent is then difficult to disperse evenly, and this tends to cause fogging in the formed image and contamination of a latent image carrying member with toner components. Too large an amount of charge control agent used leads to poorer resistance to environment, resulting in image faults in the formed image due to insufficient charging under high temperature and high humidity and contamination of a latent image carrying member with toner components.

### (Magnetic Powder)

The toner core particle may contain magnetic powder. Suitably usable as the material of the magnetic powder is, for example, a ferromagnetic metal (specifically, iron, cobalt, nickel, an alloy containing at least one of these metals, or the like), a ferromagnetic metal oxide (specifically, ferrite, magnetite, chromium dioxide, or the like), or a material having been subjected to ferromagnetization treatment (specifically, a carbon material endowed with ferromagnetism through heat treatment or the like). To suppress the elution of metal ions (such as ferric ions) from the magnetic powder, it is preferable to use magnetic particles with treated surfaces. A single type of magnetic powder may be used independently, or two or more types of magnetic powder may be used together.

### (Shell Material)

The toner core particle may, if so desired, have its surface coated with a shell layer. In a case where a shell layer is formed on the toner core particle, the shell layer is formed of resin fine particles. To give an adequate surface adsorption force to the shell layer, it is particularly preferable that the shell layer includes a resin film chiefly formed of aggregated resin particles of which the glass transfer point is 50° C. or higher but 100° C. or lower, that the number average roundness of heat-resistant particles of which the resin film is formed is 0.55 or higher but 0.75 or lower, that the heat-resistant particles contain resin containing: at least one type of repeating unit derived from a styrene-based monomer; a repeating unit having an alcoholic hydroxyl group; and a repeating unit derived from a nitrogen-containing vinyl compound, and that among the repeating units contained in the resin contained in the heat-resistant particles, the repeating unit derived from a styrene-based monomer has the highest mass percentage.

Regarding the shell layer as described above (i.e., the resin film chiefly formed of aggregated heat-resistant particles), in order to ensure sufficient heat-resistant preservability, fixability, and chargeability of the toner, it is preferable that the shell layer has a thickness of 10 nm or more but 35 nm or less. The thickness of a shell layer can be measured by analyzing a transmission electron microscope (TEM) image of a section of a toner particle using commercially available image analysis software (e.g., WinROOF, manufactured by Mitani Corporation). Note that if the thickness of a shell layer is not uniform in a toner particle, the thickness of the shell layer is measured at each of four locations that are evenly spaced from each other (specifically, four locations at which two orthogonal straight lines intersecting with each other at substantially the center of a cross section of the toner particle intersect with the shell layer), and the arithmetic mean of the four measured values is determined to be an evaluation value (the thickness of the shell layer) for the toner particle. A boundary between the toner core particle and the shell layer can be confirmed, for example, by selectively dying only the shell layer between the toner core and the shell layer. In a case where the boundary between the toner core and the shell layer is unclear in the TEM image, the boundary between the toner core and the shell layer can be clarified by mapping characteristic elements contained in the shell layer in the TEM image using a combination of TEM and electron energy loss spectroscopy (EELS).

Regarding the shell layer as described above (i.e., the resin film chiefly formed of aggregated heat-resistant particles), in order to ensure sufficient heat-resistant preservability, fixability, and chargeability of the toner, it is preferable that the shell layer cover at least 50% or more but 80% or less of the surface area of the toner core particle. The area ratio of a region in the surface of the toner core particle that is covered with the shell layer can be measured by capturing an image of the surface of the toner particle (for example, a toner particle dyed in advance) using an electron microscope and analyzing the captured image using commercially available image analysis software.

### (External Additive)

In the toner according to the present disclosure, the toner base particle is treated with an external additive. The external additive used in the toner according to the present disclosure at least contains an inorganic particle and a resin particle.

### (Inorganic Particle)

Examples of the inorganic particles usable include metal oxides such as silica, alumina, titanium oxide, magnesium oxide, zinc oxide, strontium titanate, and barium titanate. Silica or titanium oxide is particularly preferable. Among these particles, one type may be used or two or more types may be used in a mixed manner. The inorganic particle preferably has an average particle size of 10 nm or more but 100 nm or less.

### (Resin Particle)

The material of the resin particle is not particularly limited so long as ΔSP1 and ΔSP2 mentioned previously satisfy Expressions (1) and (2), respectively. Incidentally, the resin particle may be subjected to surface treatment. Examples of the surface treatment in that case include hydrophobization treatment, positive-charge imparting treatment, and conductivity treatment.

In a case where the toner base particle contains a polyester resin as the binder resin and the resin of which the resin particle is formed is a cross-linked resin, in order to easily adjust ΔSP2 such that it satisfies Expression (2), the cross-linked resin is preferably a polymer of a styrene-based monomer, an acrylic acid-based monomer, and a cross-linking agent having two or more unsaturated bonds (hereinafter may also be referred to as specific cross-linked polymer).

Examples of the styrene-based monomer for synthesizing the specific cross-linked polymer include styrene, o-methylstyrene, m-methylstyrene, p-methylstyrene, p-phenylstyrene, p-ethylstyrene, 2,4-dimethylstyrene, p-t-butylstyrene, p-n-hexylstyrene, p-n-octylstyrene, p-n-nonylstyrene, p-n-decylstyrene, and p-n-dodecylstyrene.

Examples of the acrylic acid-based monomer for synthesizing the specific cross-linked polymer include (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, n-octyl (meth)acrylate, 2-ethylhexyl (meth)acrylate, stearyl (meth)acrylate, lauryl (meth)acrylate, and phenyl (meth)acrylate.

Examples of the cross-linking agent having two or more unsaturated bonds for synthesizing the specific cross-linked polymer include N,N′-methylene-bisacrylamide, divinylbenzene, ethylene glycol diacrylate, ethylene glycol dimethacrylate, diethylene glycol diacrylate, tetraethylene glycol diacrylate, polyethylene glycol diacrylate, 1,4-butanediol diacrylate, 1,6-hexanediol diacrylate, tripropylene glycol diacrylate, trimethylolpropane triacrylate, pentaerythritol triacrylate, pentaerythritol tetraacrylate. 1,4-butanediol dimethacrylate, and 1,6-hexanediol dimethacrylate.

In order to obtain a toner that excels in charge stability and heat-resistant preservability, preferable as the cross-linking agent having two or more unsaturated bonds is ethylene glycol dimethacrylate.

In order to obtain a toner excels further in charge stability and heat-resistant preservability, it is preferable that the binder resin of the toner base particle be polyester resin and the resin particle be formed of a polymer (cross-linked polymer) of styrene, methyl methacrylate, and ethylene glycol dimethacrylate.

The formation method for the resin particle is not particularly limited. Examples of the formation method for the resin particle include the emulsion polymerization method, the seed polymerization method, and the dispersion polymerization method. Further, in the present embodiment, the resin particle may be a commercially available product.

Further, another external additives may also be used together with the previously described inorganic particle and resin particle. The type of the external additive to be used together with the resin particle is not particularly limited within the scope consistent with the object of the present disclosure, and may be appropriately selected from among external additives conventionally used for toner. Two or more of those external additives may be used in combination.

### [Method for Producing Toner]

Next, a production method for the toner according to the present disclosure will be described. The production method for the toner includes a method for producing the toner core particle and a method for external addition treatment for attaching the external additive to the surface of the toner base particle. The method for producing the toner core particle is not particularly limited so long as it can form the toner core particle having a predetermined structure. Further, as necessary, the toner core particle coated with the shell layer may be used as the toner base particle. As a suitable production method for the positively chargeable toner described above, the following description discusses one by one a method for producing the toner core particle, a method for forming the shell layer, and a method for external addition treatment.

### (Method for Producing Toner Core Particle)

The method for producing the toner core particle is not particularly limited so long as it can satisfactorily disperse any components such as a colorant, a release agent, a charge control agent, and a magnetic powder in a binder resin. A suitable method for producing the toner core particle is a pulverization method or an aggregation method, for example.

The pulverization method is a method in which, first, a binder resin is mixed with other components such as a colorant, a release agent, a charge control agent, and a magnetic powder using a mixer or the like; then the binder resin and the components blended with it are melted and kneaded using a uniaxial or biaxial kneader or the like; and then, after being cooled down, the kneaded product is pulverized and classified. The average particle size of the toner core particle is not particularly limited within the scope consistent with the object of the present disclosure; in general, it is preferably 5 μm or more but 10 μm or less.

The aggregation method is a method in which fine particles of a binder resin, a release agent, a charge control agent, and a colorant are caused to aggregate in an aqueous solvent containing these fine particles until particles having a desired diameter are obtained. Thereby, aggregated particles are formed containing the binder resin, the release agent, the charge control agent, and the colorant. Subsequently, the obtained aggregated particles are heated to coalesce the components contained in the aggregated particles. In this manner, toner core particles having a desired particle size are obtained.

### (Method for Forming Shell Layer)

In a case where the surface of the toner core particle is coated with a shell layer, the shell layer is formed by attaching resin fine particles to the surface of the toner core particle.

A more specific method will be described. First, in a mixing apparatus, hydrochloric acid is added to ion exchange water to prepare an aqueous solvent that is weakly acidic (for example, with a pH value selected from the range of three or more but five or less). Subsequently, to the aqueous solvent with the so adjusted pH value, as a shell material, a dispersion liquid (suspension) of resin fine particles is added along with toner core particles.

Subsequently, while the mixture liquid containing the shell material and the toner core particles is stirred, the temperature of the mixture liquid is raised up to a predetermined holding temperature (e.g., a temperature selected from the range of 50° C. or higher but 90° C. or lower) at a predetermined rate (e.g., a rate selected from the range of 0.1° C./min or higher but 3° C./min or lower). Then, while the mixture liquid is stirred, its temperature is held at the holding temperature for a predetermined time (e.g., a length of time selected from the range of 30 minutes or more but 4 hours or less). It is considered that, while the temperature of the mixture liquid is held high, a reaction (fixation of the shell layer) proceeds between the toner core particle and the shell material. The shell material binds to the toner core particle to form the shell layer. The formation of the shell layer on the surface of the toner core particle in the mixture liquid yields a dispersion liquid of the toner base particles.

### (Method for External Addition Treatment)

The method for treatment of the toner base particle with the external additive is not particularly limited; the toner base particle can be treated by any conventionally known method. Specifically, the toner base particle is treated with the external additive using a mixer such as a Henschel mixer or a Nauta mixer under treatment conditions adjusted such that particles of the external additive do not sink into the toner base particle.

The toner according to the present disclosure described above excels in fixability and heat-resistant preservability, so that in cases where images are formed for a long period in various environments including a high-temperature high-humidity environment and a low-temperature low-humidity environment, the toner can be charged with the desired amount of charge, making it possible to form images with the desired density. Thus, the toner according to the present disclosure for development of electrostatic latent images can be used suitably in a variety of image forming apparatuses. Now, the effects of the present disclosure will be described more specifically by way of examples. The present disclosure is not limited in any way by those examples.

### EXAMPLES

### Production Example 1

### (Production of Toner Base Particles)

The following were mixed in a Henschel mixer (FM-10 model, manufactured by Mitsui Mining Corporation) to obtain a mixture: as a binder resin, 82 mass % of polyester resin (HP-313, manufactured by The Nippon Synthetic Chemical Industry Co., Ltd.); as a colorant, 6.0 mass % of carbon black (MA-100, a product of Mitsubishi Chemical Corporation); 2.0 mass % of a charge control agent (N-01, manufactured by ORIENT CHEMICAL INDUSTRIES CO., LTD); 4.0 mass % of a charge control agent (FCA-201-PS, manufactured by FUJIKURA KASEI CO., LTD); and as a release agent, 6.0 mass % of ester wax (WEP-3, manufactured by NOF CORPORATION). Next, the mixture was melted and kneaded using a biaxial extruder (TEM-26SS, manufactured by Toshiba Machine Co., Ltd.) to obtain a kneaded product. The kneaded product was then coarsely pulverized using a Rotoplex granulator (manufactured by Toa Machine Industry) to about 2 mm, and was then finely pulverized using a mechanical pulverizer (Turbomill, manufactured by Turbo Industry) to obtain a finely pulverized product. The finely pulverized product was then classified using an air classifier (EJ-L-3 (LABO) model, manufactured by Nittetsu Mining Co., Ltd.) to obtain toner core particles with a volume average particle size (D50) of 7.0 μm. The volume average particle size of the toner core particles was measured using a Coulter Counter Multisizer 3 (manufactured by Beckman Coulter, Inc.).

### Production Example 2

### (Production of Resin Particles)

28 mass parts of styrene, 42 mass parts of acrylonitrile, 30 mass parts of ethylene glycol dimethacrylate, 4.5 mass parts of potassium persulfate (water-soluble polymerization initiator), 100 mass parts of ion exchange water, and 2.0 mass parts of cationic surfactant (cetyltrimethylammonium chloride) were put in a round flask, stirred with an anchor-type stirring blade at the rate of 100 rpm, and subjected to soap-free emulsion polymerization at 70° C. for eight hours, thereby obtaining a dispersion liquid of resin particles.

The obtained dispersion liquid was purified by an ultrafiltration device and then dried using a spray drying method, thereby producing resin particles. The particle size was adjusted by the nozzle pore size and spray velocity to produce resin particles A. The average primary particle size of the resin particles A measured with a scanning electron microscope (JSM-7600F, manufactured by JEOL Ltd.) was 42 nm.

Further, resin particles B to M were obtained using the same method as the resin particles A, except for the changes in the type and the amount of the combined monomer. Further, resin particles N were obtained using the same method as the resin particles A, except for the replacement of the cationic surfactant to an anionic surfactant (sodium dodecylbenzenesulfonate).

### (Measurement of Hardness of Resin Particles)

“AFM5000II” (manufactured by Hitachi High-Tech Science Corporation) was used as a measuring device. “SI-DF40 Backside A1 Coating” (manufactured by Hitachi High-Tech Science Corporation) was used as a cantilever. This cantilever had a tip radius R of 10 nm, a probe height D of 12.5 μm, a lever length L of 125 μm, a lever width W of 30 μm, a lever thickness T of 4 μm, and a spring constant of 42 N/m. By measuring the AFM surface hardness of the surface of the resin particle, a force curve was obtained. As a measurement sample, for a stable sample base, a resin particle pellet with a diameter of 20 mm was produced. The measurement conditions were as follows: the measurement room temperature was 23.5° C.; the measurement room humidity was 50% RH; the measurement was conducted in atmospheric air; the measurement area was 6 μm×6 μm, the torsion spring constant was 1 N/m; and the resonance frequency was 150 Hz. Stress at the probe displacement amount of 40 nm was measured at 30 points and then averaged.

Regarding the resin particles A to N, their SP values, hardnesses, and particle sizes are shown in Table 1, along with the types and amounts (mass parts) of combined monomers and surfactants.

TABLE 1

| | Materials (mass parts) | | | | | Physical Properties | | |
|---|---|---|---|---|---|---|---|---|
| Resin | | | EGDM | Cationic | Anionic | SP | Hardness | Particle |
| Particle | Styrene | Acrylonitrile | (*1) | Surfactant | Surfactant | Value | [μN] | Size [nm] |
| A | 28 | 42 | 30 | 2 | — | 9.5 | 1.1 | 42 |
| B | 37 | 21 | 42 | 2 | — | 9.4 | 1.6 | 70 |
| C | 28 | 42 | 30 | 2 | — | 9.5 | 1.1 | 71 |
| D | 22 | 42 | 36 | 2 | — | 9.7 | 1.3 | 71 |
| E | 28 | 42 | 30 | 2 | — | 9.5 | 1.1 | 107 |
| F | 40 | 20 | 40 | 2 | — | 9.3 | 1.5 | 70 |
| G | 19 | 31 | 50 | 2 | — | 9.8 | 2.0 | 72 |
| H | 0 | 40 | 60 | 2 | — | 10.3 | 2.3 | 70 |
| I | 28 | 45 | 27 | 2 | — | 9.5 | 0.9 | 71 |
| J | 32 | 48 | 20 | 2 | — | 9.4 | 0.5 | 70 |
| K | 0 | 70 | 30 | 2 | — | 9.8 | 0.3 | 70 |
| L | 28 | 42 | 30 | 2 | — | 9.5 | 1.1 | 120 |
| M | 28 | 42 | 30 | 2 | — | 9.5 | 1.1 | 31 |
| N | 37 | 21 | 42 | — | 2 | 9.4 | 1.6 | 70 |

(*1); ethylene glycol dimethacrylate

### Production Example 3

### (External Addition Treatment of Toner Base Particles)

Relative to 100 mass parts of the toner base particles obtained in Production Example 1, 1.5 mass parts of positively chargeable silica fine particles (CAB-O-SIL TG-308F, manufactured by Cabot Corporation) and 1.0 mass parts of titanium oxide (MT-500B, TAYCA CORPORATION) were mixed in a Henschel mixer (FM-10 model, manufactured by Mitsui Mining Corporation) at a rotation rate of 3500 rpm for five minutes. After that, the resin particles A to N obtained in Production Example 2 were respectively loaded by predetermined mass parts, mixed at a rotation rate of 3500 rpm for five minutes. In this manner, the resin particles were externally added. The coverage ratio of the resin particles on the surface of the toner base particle was adjusted to be 30%. In this way, toners respectively having different resin particles externally added thereto to be used in Practical Examples 1 to 5 and Comparative Examples 1 to 9 were produced.

### Production Example 4

### (Production of Carrier)

After dissolving 2 kg of an epoxy resin (Epicote 1004, manufactured by Japan Epoxy Resin Inc.) in 20 L of acetone, 100 g of diethylenetriamine and 150 g of phthalic anhydride were added and mixed, thereby producing a coating liquid.

By using a fluidized bed coating machine (SFC-5, manufactured by Freund Corporation), while making 10 kg of a carrier core (F-50, manufactured by Powdertech Co., 50 μm in particle size) flow, 80° C. hot air was sent and a coating liquid was sprayed to the carrier core, resulting in the carrier core coated with the coating liquid. The carrier core coated with the coating liquid was fired at 180° C. for one hour using an electric furnace to obtain carrier particles.

### Production Example 5

### (Production of Two-Component Developer)

The carrier particles obtained in Production Example 4 and the toner obtained in Production Example 3 were mixed for 30 minutes using a ball mill such that the toner was 8 mass % relative to the carrier, and thereby two-component developers of the Practical Examples 1 to 5 and of Comparative Examples 1 to 9 were prepared.

### [Evaluation of UFP Generation Amount and Image Properties]

### (Evaluation Method for UFP Generation Amount)

To the exhaust port of a differential thermal-thermogravimetric (TG/DTA) simultaneous measurement device (STA7200, manufactured by Hitachi High-Tech Science Corporation), the air-intake port of a fast response particle sizer (FMPS 3091, manufactured by TOKYO DYLEC CORP.) was fitted. The exhaust flow rate of the differential thermal-thermogravimetric simultaneous measurement device was set to 0.1 L/min, and the intake flow rate of the fast response particle sizer was set to 10 L/min. After that, using the differential thermal-thermogravimetric simultaneous measurement device, 10 mg of a measurement sample (specifically, each of the two-component developers of Practical Examples 1 to 5 and of Comparative examples 1 to 9) was heated from the normal temperature to 220° C. at a heating rate of 20° C./min, and then maintained at 220° C. for 10 minutes. Simultaneously with the start of the measurement program by the differential thermal-thermogravimetric simultaneous measurement device, the particle number concentration of fine particles generated was measured. The evaluation criteria for UFP generation amount are shown below:
G (Good): The UFP total number concentration was less than 1.50×10⁵ particles/cm³ (acceptable in practical use);
P (Poor): The UFP total number concentration was 1.50×10⁵ particles/cm³ or more (not acceptable in practical use).

### (Evaluation Method for Image Properties)

Each of the two-component developers of Practical Examples 1 to 5 and of Comparative Examples 1 to 9 was loaded in the developing device of an evaluation machine (a modified version of TASKalfa 6054ci W, manufactured by Kyocera Document Solutions), durable printing of 5 million sheets was performed at a print ratio of 5% in a normal-temperature normal-humidity environment (temperature: 23.5° C., humidity: 50%), and the charge stability, the transfer properties, the drum-cleaning properties, and the drum filming properties of the toners were evaluated by the methods described below.

### (Charge Stability)

At the start of printing and after printing on 5 million sheets (after durable printing), the developer remaining on the developing roller was collected, and then only the toner from the collected developer was sifted through a sieve (a stainless steel twill-woven sieve with a wire diameter of 0.0027 mm) with an aperture of 38 μm to be sucked into a compact suction-type charge measurement device (one manufactured by TREK, INC.) to measure its charge amount. Further, the toner charge amount at the start of printing was measured in the same manner in a high-temperature high-humidity environment (temperature: 32.5° C., humidity: 80%) as well. The evaluation criteria for charge stability are shown below:
E (Excellent): A charge amount of 25 μC/g or more but less than 35 μC/g (acceptable in practical use);
G (Good): A charge amount of 15 μC/g or more but less than 25 μC/g (acceptable in practical use);
P (Poor): A charge amount of less than 15 μC/g or 35 μC/g or more (not acceptable in practical use).

### (Transfer Properties)

In the same manner as in the measurement of charge amount, transfer properties were measured after printing 5 million sheets (after durable printing). Transfer efficiency is calculated according to the expression “Transfer Efficiency (%)=B/A×100” where A is the weight of adhesion toner on the transfer belt and B is the adhesion of toner on the media, both as observed when a solid image (evaluation image) of vertically 0.5 cm and horizontally 20 cm is output. The toner weight A on the transfer belt and the toner weight B on the media were measured in the following manner: the evaluation machine was stopped respectively at a timing immediately after image development and at a timing immediately before image fixing to collect the toner using a compact suction-type charge measurement device (one manufactured by Trek Inc.), and then the respective weights of the collected toner were measured using a precision balance. The evaluation criteria for transfer properties are shown below:
E (Excellent): Transfer efficiency of 90% or higher (acceptable in practical use);
G (Good): Transfer efficiency between of 85% and 90% (acceptable in practical use);
P (Poor): Transfer efficiency of 85% or lower (not acceptable in practical use).

### (Drum Cleaning Properties)

After durable printing was performed on 5 million sheets, a halftone image was printed. The obtained halftone image was visually inspected for a vertical streak-like image defect. Further, after the printing of the halftone image, the surface of the charger was visually inspected for a residual toner component. The evaluation criteria for cleaning performance are shown below:
G (Good): No vertical streak-like image defect in the halftone image and no residual toner component on the charger surface (acceptable in practical use);
F (Fair): No vertical streak-like image defect in the halftone image and just a small amount of residual toner component on the charger surface (acceptable in practical use);
P (Poor): A vertical streak-like defect in the halftone image and a residual toner component on the charger surface (not acceptable in practical use).

### (Drum Filming Properties)

After performing durable printing on 5 million sheets, the surface of the photosensitive drum was visually inspected for toner adhesion. The criteria for drum filming properties are shown below:
G (Good): No toner adhesion observed upon visual inspection (acceptable in practical use);
P (Poor): Toner adhesion observed upon visual inspection (not acceptable in practical use).

The evaluation results of the two-component developers of Practical Examples 1 to 5 and of Comparative Examples 1 to 9 in terms of UPP generation amount, charge stability, transfer properties, drum cleaning properties, and drum filming properties are shown in Table 2. In Table 2, the numerical values of UFP generation amount, toner charge amount, and transferability are measured values.

TABLE 2

| | Resin Particle | | | | | | |
|---|---|---|---|---|---|---|---|
| | | | | Particle | Externally Added | | |
| | | SP | Hardness | Size | Amount | Binder Resin | Release Agent |
| Developer | Type | Value | [μN] | [nm] | [mass parts] | SP Value | SP Value |
| Practical | A | 9.4 | 1.1 | 42 | 0.6 | 11 | 8.6 |
| Example 1 | | | | | | | |
| Practical | B | 9.5 | 1.6 | 70 | 1.1 | 11 | 8.6 |
| Example 2 | | | | | | | |
| Practical | C | 9.5 | 1.1 | 71 | 1.1 | 11 | 8.6 |
| Example 3 | | | | | | | |
| Practical | D | 9.7 | 1.3 | 71 | 1.1 | 11 | 8.6 |
| Example 4 | | | | | | | |
| Practical | E | 9.5 | 1.1 | 107 | 1.6 | 11 | 8.6 |
| Example 5 | | | | | | | |
| Comparative | F | 9.3 | 1.5 | 70 | 1.1 | 11 | 8.6 |
| Example 1 | | | | | | | |
| Comparative | G | 9.8 | 2 | 72 | 1.1 | 11 | 8.6 |
| Example 2 | | | | | | | |
| Comparative | H | 10.3 | 2.3 | 70 | 1.2 | 11 | 8.6 |
| Example 3 | | | | | | | |
| Comparative | I | 9.5 | 0.9 | 71 | 1.1 | 11 | 8.6 |
| Example 4 | | | | | | | |
| Comparative | J | 9.4 | 0.5 | 70 | 1.1 | 11 | 8.6 |
| Example 5 | | | | | | | |
| Comparative | K | 9.8 | 0.3 | 70 | 1.2 | 11 | 8.6 |
| Example 6 | | | | | | | |
| Comparative | L | 9.5 | 1.1 | 120 | 1.8 | 11 | 8.6 |
| Example 7 | | | | | | | |
| Comparative | M | 9.5 | 1.1 | 31 | 0.5 | 11 | 8.6 |
| Example 8 | | | | | | | |
| Comparative | N | 9.4 | 1.5 | 70 | 1.1 | 11 | 8.6 |
| Example 9 | | | | | | | |

| | Evaluation Results | | | | | |
|---|---|---|---|---|---|---|
| | UFP | Toner Charge Amount [μC/g] | | | | |
| | Generation | | After | Transfer- | Drum | Drum |
| Developer | [particles/cm³] | Initially | Durability | ability | Cleaning | Filming |
| Practical | G/0.6 × 10E5 | E/31 | G/15 | G/86 | G | G |
| Example 1 | | | | | | |
| Practical | G/0.9 × 10E5 | E/30 | G/22 | E/92 | G | G |
| Example 2 | | | | | | |
| Practical | G/1.1 × 10E5 | E/32 | G/20 | E/90 | G | G |
| Example 3 | | | | | | |
| Practical | G/1.3 × 10E5 | E/32 | G/16 | G/88 | G | G |
| Example 4 | | | | | | |
| Practical | G/1.4 × 10E5 | E/32 | G/24 | E/95 | G | G |
| Example 5 | | | | | | |
| Comparative | G/0.7 × 10E5 | E/29 | G/24 | E/90 | F | G |
| Example 1 | | | | | | |
| Comparative | P/1.5 × 10E5 | E/33 | P/14 | G/86 | G | G |
| Example 2 | | | | | | |
| Comparative | P/2.2 × 10E5 | E34 | P/11 | P/80 | G | G |
| Example 3 | | | | | | |
| Comparative | G/1.1 × 10E5 | E/32 | G/21 | E/90 | P | P |
| Example 4 | | | | | | |
| Comparative | G/0.9 × 10E5 | E/31 | G/22 | E/92 | P | P |
| Example 5 | | | | | | |
| Comparative | P/1.6 × 10E5 | E/33 | P/13 | G/86 | P | P |
| Example 6 | | | | | | |
| Comparative | P/1.8 × 10E5 | E/33 | G/18 | E/91 | P | G |
| Example 7 | | | | | | |
| Comparative | G/0.4 × 10E5 | E/30 | P/13 | P/83 | G | G |
| Example 8 | | | | | | |
| Comparative | G/1.1 × 10E5 | G/18 | P/7 | P/72 | G | G |
| Example 9 | | | | | | |

(E: Excellent, G: Good, F: Fair, P: Poor)

As is clear from Table 2, with the developers of Practical Examples 1 to 5, where ΔSP1, which is the difference between the SP value of the release agent in the toner base particle and the SP value of the resin particle, was 0.8 to 1.1 (cal/cm³)^{1/2}, the UFP generation amount was small, namely 0.6 to 1.4 (particles/cm³). This is considered to be because of the following reason: since the resin particle tends to be fixed on the release agent exposed on the surface of the toner base particle, on application of thermal energy and pressure at the fixing portion, thermal decomposition of the release agent unnecessary for releasing was suppressed, reducing the UFP generation amount.

In the developers of Practical Examples 1 to 5, where ΔSP2, which is the difference between the SP value of the binder resin in the toner base particle and the SP value of the resin particle was 1.3 to 1.6 (cal/cm³)^{1/2}, the resin particle was unlikely to be caused to sink into the toner base particle by environmental changes or mechanical stress. As a result, charge stability was also good. With the developers of Practical Examples 1 to 5, where the hardness of the resin particle was 1 μN or higher, toner adherence (filming) on the surface of the photosensitive drum was suppressed, contributing to good cleaning properties.

By contrast, in the developer of Comparative Example 1, since ΔSP2 was large, namely 1.7 (cal/cm³)^{1/2}, and the SP values of the binder resin and the resin particle were far apart, it was difficult to fix the resin particle to the binder resin exposed on the surface of the toner base particle. As a result, the amount of resin particles detached was increased, so that the drum cleaning properties were degraded.

Further, in the developers of Comparative Examples 2 and 3, where ΔSP2 was small, namely 1.2 (cal/cm³)^{1/2} or less, and the SP values of the binder resin and the resin particle were close to each other, the resin particle was liable to sink into the toner base particles, resulting in degraded charge stability.

Further, with the developers of Comparative Examples 4 to 6, where the hardness of the resin particle was lower than 1 μN, toner adherence (filming) on the surface of the photosensitive drum occurred, which induced unstable stick-slip motion of a cleaning blade, resulting in poor cleaning of the photosensitive drum.

Further, with the developer of Comparative Example 7, where the particle size of the resin particle was large, namely 120 nm, it was difficult to fix the resin particle to the surface of the toner base particle. As a result, the amount of resin particles detached was increased, resulting in poor cleaning of the photosensitive drum. On the other hand, with the developer of Comparative Example 8, where the particle size of the resin particle was small, namely 30 nm, the resin particle provided only a small spacer effect, and thus the resin particle was caused to be more likely to sink into the toner base particle due to stress, resulting in degraded charge stability. With the developer of Comparative Example 9, where an anionic surfactant was used for the resin particle, the positive chargeability of the toner was degraded, resulting in degraded charge stability. Moreover, response to the transfer electric field becomes difficult, and thus transferability was also degraded.

The above results confirm that by setting ΔSP1, ΔSP2, and the hardness and particle size of the resin particle within appropriate ranges, a two-component developer can be obtained that is capable of suppressing the UFP generation amount while achieving excellence in properties such as charge stability both at the start of printing and after durable printing, transfer properties, drum cleaning properties, and drum filming properties.

The present disclosure finds applications in positively chargeable toner and two-component developer containing the positively chargeable toner for use in an electrophotographic method. By using the present disclosure, it is possible to provide positively chargeable toner, with excellent transfer properties and drum-cleaning properties, in which generation of UFPs resulting from the thermal decomposition of a release agent is suppressed, and to provide two-component developer including the positively chargeable toner.

What is claimed is:

1. A positively chargeable toner comprising toner particles each including: a toner base particle containing, at least, a binder resin, a colorant, and a release agent; and an external additive attached to a surface of the toner base particle,
wherein
the external additive includes an inorganic particle and a resin particle,
the resin particle contains a cationic surfactant, has a volume average particle size of 40 nm or more but 110 nm or less, and has a hardness of 1 μN or higher when measured with a probe displacement of 40 nm, and
expressions (1) and (2) below are satisfied, where ΔSP1 is a difference between an SP value of the release agent and an SP value of the resin particle, and ΔSP2 is a difference between an SP value of the binder resin and the SP value of the resin particle:
$$0.8 ≦ Δ SP 1 ≦ 1.1 {( cal / {cm}^{3} )}^{1 / 2} ; \qquad ( 1 )$$
$$1.3 ≦ Δ SP 2 ≦ 1.6 {( cal / {cm}^{3} )}^{1 / 2} . \qquad ( 2 )$$

2. The positively chargeable toner according to claim 1,
wherein
an amount of the resin particle added is 0.6 mass parts or more but 1.1 mass parts or less relative to 100 mass parts of the toner base particle.

3. The positively chargeable toner according to claim 1,
wherein
the toner base particle contains a polyester resin as the binder resin.

4. The positively chargeable toner according to claim 3,
wherein
the resin particle is formed from a polymer of a styrene-based monomer, an acrylic acid-based monomer, and a cross-linking agent.

5. The positively chargeable toner according to claim 4,
wherein
the cross-linking agent is ethylene glycol dimethacrylate.

6. A two-component developer, comprising:
the positively chargeable toner according to claim 1; and
a carrier capable of positively charging the positively chargeable toner by friction.
